(19) United States
(12) Patent Application Publication
(10) Pub. No.: US 2022/0252008 A1
(43) Pub. Date: Aug. 11, 2022

(54) PROPULSION SYSTEM CONFIGURATIONS AND METHODS OF OPERATION

(71) Applicant: General Electric Company, Schenectady, NY (US)

(72) Inventors: Arthur William Sibbach, Boxford, MA (US); Brandon Wayne Miller, Liberty Township, OH (US); David Marion Ostdiek, Liberty Township, OH (US)

(21) Appl. No.: 17/170,116

(22) Filed: Feb. 8, 2021

(51) Int. Cl. F02C 6/20; F02C 3/06

(52) U.S. Cl. CPC F02C 6/206; F05D 2220/40; F05D 2220/323; F02C 3/06

(57) ABSTRACT

Propulsion systems and methods of operation are provided. An exemplary propulsion system comprises a rotating element; a stationary element; an inlet duct having an inlet between the rotating and stationary elements, the inlet passing radially inward of the stationary element; a ducted fan disposed in the inlet duct downstream of the inlet and having an axis of rotation and a plurality of blades; a gas turbine engine core having a high pressure compressor, a combustor, and a high pressure turbine in serial relationship; and a booster compressor disposed between the ducted fan and the gas turbine engine core. At least one of the ducted fan and the booster compressor is driven by a variable speed power source such that the rotational speed of the ducted fan and/or booster compressor is controllable independently from the rotational speed of any rotor of the propulsion system.

### FIELD

The present subject matter relates to propulsion systems, particularly to low pressure “booster” compressors for gas turbine engine propulsion systems.

### BACKGROUND

Gas turbine engines or propulsion systems employing an open rotor design architecture are known. A turbofan engine operates on the principle that a central gas turbine core drives a bypass fan, the fan being located at a radial location between a nacelle of the engine and the engine core such that the fan operates within a “duct” formed by the inner surface of the nacelle but air driven by the fan “bypasses” the central gas turbine core. An open rotor propulsion system instead operates on the principle of having the bypass fan located outside of the engine nacelle, in other words, “unducted.” This permits the use of larger fan blades able to act upon a larger volume of air than for a turbofan engine, and thereby improves propulsive efficiency over conventional ducted engine designs.

In addition to the typical elements of a gas turbine engine core, namely a high pressure (HP) compressor, a combustor, and a high pressure (HP) turbine, in serial relationship, many gas turbine engines also include a low pressure “booster” compressor upstream of the HP compressor which aids in providing a source of pre-compressed air to increase overall efficiency and power output. Booster compressors are typically driven through a rotor that is in turn driven by the HP turbine, a low pressure (LP) turbine, or an intermediate (IP) turbine, either directly or indirectly through a gearbox or transmission.

The booster compressors in such configurations are driven at a fixed rotational speed relative to one of the turbines, yet in operation gas turbine engines may be operated at varied power settings, flight speeds, altitudes, temperatures, and other conditions. Thermal efficiency, and in turn fuel consumption, may be less than optimal under certain operating conditions.

It would be desirable to provide a propulsion system that may be configured and operated to deliver improved overall operational efficiency of the propulsion system.

### BRIEF DESCRIPTION

Aspects and advantages of the invention will be set forth in part in the following description, or may be obvious from the description, or may be learned through practice of the invention.

In one aspect of the present subject matter, a propulsion system is provided. The propulsion system comprises a rotating element and a stationary element. The propulsion system further comprises an inlet duct having an inlet between the rotating element and the stationary element. The inlet passes radially inward of the stationary element. The propulsion system also comprises a ducted fan disposed in the inlet duct downstream of the inlet. The ducted fan has an axis of rotation and a plurality of blades. The propulsion system further comprises a gas turbine engine core having a high pressure compressor, a combustor, and a high pressure turbine in serial relationship. A booster compressor is disposed between the ducted fan and the gas turbine engine core. At least one of the ducted fan and the booster compressor is driven by a variable speed power source such that the rotational speed of the at least one of the ducted fan and the booster compressor is controllable independently from the rotational speed of any rotor of the propulsion system.

In another aspect of the present subject matter, a method of operating a propulsion system is provided. The method comprises operating a first fan assembly to produce a first stream of air; directing a portion of the first stream of air into a second fan assembly, the second fan assembly disposed in an inlet duct; operating the second fan assembly to produce a second stream of air; and operating a booster compressor. Operating the second fan assembly and operating the booster compressor comprises operating at least one of the second fan assembly and the booster compressor at a rotational speed independent of a rotational speed of any rotor of the propulsion system.

In yet another aspect of the present subject matter, a propulsion system is provided. The propulsion system comprises an unducted fan having an axis of rotation and a first plurality of first blades; an inlet duct having an inlet downstream of the unducted fan; and a ducted fan disposed in the inlet duct downstream of the inlet. The ducted fan is rotatable about the axis of rotation and has a second plurality of blades. The ducted fan is driven by a variable speed power source such that a rotational speed of the ducted fan is controllable independently from a rotational speed of any rotor of the propulsion system. Downstream of the ducted fan, the inlet duct divides into a radially inward core duct and a radially outward fan duct. A stream of air flowing through the fan duct is capable of producing at least about 2% of a total thrust of the propulsion system at takeoff.

These and other features, aspects, and advantages of the present invention will become better understood with reference to the following description and appended claims. The accompanying drawings, which are incorporated in and constitute a part of this specification, illustrate embodiments of the invention, and together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross-sectional, schematic illustration of an open rotor propulsion system in accordance with various exemplary embodiments of the present subject matter.

FIG. 2 provides an enlarged, partial cross-sectional schematic illustration of the exemplary open rotor propulsion system of FIG. 1.

FIG. 3 provides a cross-sectional, schematic illustration of a propulsion system, such as the propulsion system of FIG. 1, having a ducted fan driven by a variable speed power source and a booster compressor driven by a low pressure turbine through a connection to a low pressure rotor, according to an exemplary embodiment of the present subject matter.

FIG. 4 provides a cross-sectional, schematic illustration of a propulsion system, such as the propulsion system of FIG. 1, having a ducted fan driven by a low pressure turbine through a connection to a low pressure rotor and a booster compressor driven by a variable speed power source, according to an exemplary embodiment of the present subject matter.

FIG. 5 provides a cross-sectional, schematic illustration of a propulsion system, such as the propulsion system of FIG. 1, having both a ducted fan and a booster compressor driven by a variable speed power source, according to an exemplary embodiment of the present subject matter.

FIG. 6 provides a cross-sectional, schematic illustration of a propulsion system, such as the propulsion system of FIG. 1, having a ducted fan driven by a first variable speed power source and a booster compressor driven by a second variable speed power source, according to an exemplary embodiment of the present subject matter.

FIG. 7 provides a flow chart illustrating a method of operating a propulsion system, such as the propulsion system of FIG. 1, according to an exemplary embodiment of the present subject matter.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the word “exemplary” is used herein to mean “serving as an example, instance, or illustration.” Any implementation described herein as “exemplary” is not necessarily to be construed as preferred or advantageous over other implementations.

Further, the terms “first,” “second,” and “third” may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows. Moreover, all directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention.

The terms “coupled,” “fixed,” “attached to,” and the like refer to both direct coupling, fixing, or attaching, as well as indirect coupling, fixing, or attaching through one or more intermediate components or features, unless otherwise specified herein. Further, connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary.

The singular forms “a,” “an,” and “the” include plural references unless the context clearly dictates otherwise.

Further, as used herein, the terms “axial” or “axially” refer to a dimension along a longitudinal axis of an engine. The term “forward” used in conjunction with “axial” or “axially” refers to a direction toward the engine inlet, or a component being relatively closer to the engine inlet as compared to another component. The term “aft” or “rear” used in conjunction with “axial” or “axially” refers to a direction toward the engine exhaust, or a component being relatively closer to the engine exhaust as compared to another component. The terms “radial” or “radially” refer to a dimension extending between a center longitudinal axis (or centerline) of the engine and an outer engine circumference. Radially inward is toward the longitudinal axis and radially outward is away from the longitudinal axis.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. The approximating language may refer to being within a +/−1, 2, 4, 10, 15, or 20 percent margin in either individual values, range(s) of values, and/or endpoints defining range(s) of values.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a secondary air stream capable of increasing fluid energy to produce a minority of total propulsion system thrust. A pressure ratio of the third stream is higher than that of the primary propulsion stream (e.g., a bypass or propeller driven propulsion stream). The thrust may be produced through a dedicated nozzle or through mixing of the secondary air stream with the primary propulsion stream or a core air stream, e.g., into a common nozzle. In certain exemplary embodiments, an operating temperature of the secondary air stream is less than a maximum compressor discharge temperature for the engine and, more specifically, may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments, these operating temperatures may facilitate heat transfer to or from the secondary air stream and a separate fluid stream. Further, in certain exemplary embodiments, the secondary air stream may contribute less than 50% of the total engine thrust (and at least, e.g., 2% of the total engine thrust) at a takeoff condition or, more particularly, while operating at a rated takeoff power at sea level, static flight speed, 86 degree Fahrenheit ambient temperature operating conditions. Moreover, in certain exemplary embodiments, aspects of the secondary air stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

Generally, the present subject matter is directed to propulsion systems and methods of operating propulsion systems. More particularly, the present subject matter is directed to a propulsion system having a rotating element, such as an unducted fan; a stationary element, such as a vane array; and an inlet duct having an inlet between the rotating element and the stationary element, the inlet passing radially inward of the stationary element. A ducted fan may be disposed in the inlet duct downstream of the inlet, and a gas turbine engine core having a high pressure compressor, a combustor, and a high pressure turbine in serial relationship may be disposed downstream of the ducted fan. Further, a booster compressor may be disposed upstream of the gas turbine engine core, between the ducted fan and the gas turbine engine core. At least one of the ducted fan and the booster compressor is driven by a variable speed power source such that the rotational speed of the at least one of the ducted fan and the booster compressor is controllable independently from the rotational speed of any rotor of the propulsion system. For example, the propulsion system may comprise one or more rotors for driving the rotating element, the high pressure compressor, and/or other components of the propulsion system. The other of the ducted fan and the booster compressor may be driven by the variable speed power source, by a turbine of the propulsion system, or by a second, separate variable speed power source.

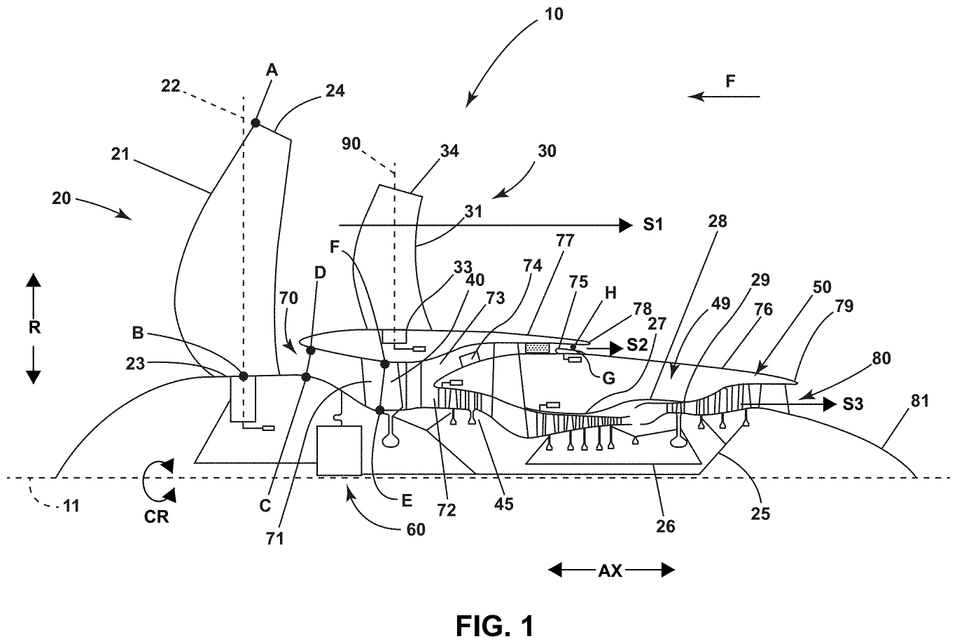

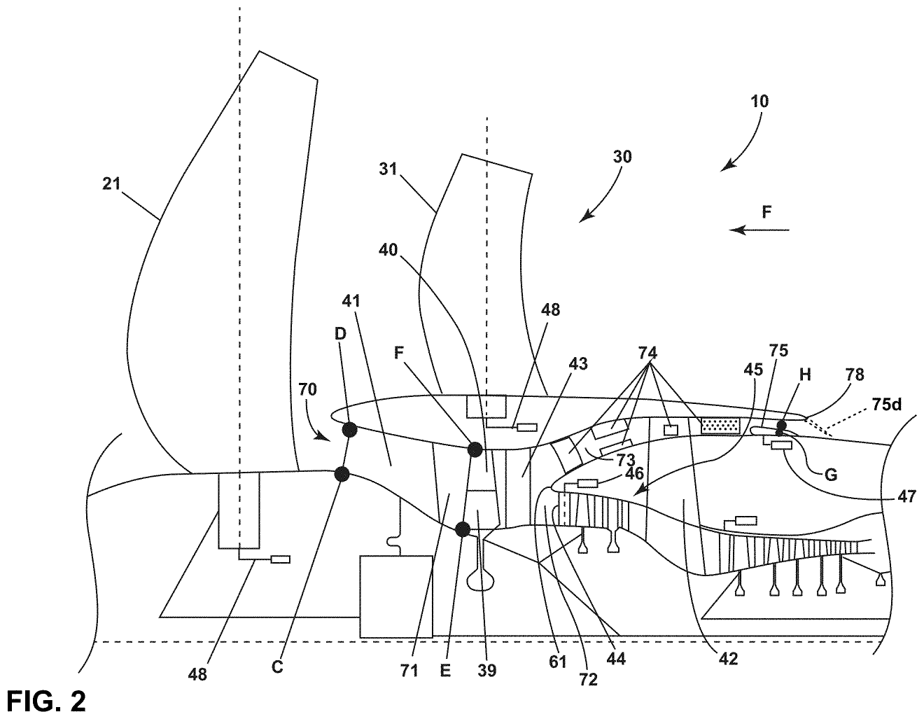

Referring now to the drawings, wherein identical numerals indicate the same elements throughout the figures, FIG. 1 is a schematic cross-sectional view of an open rotor propulsion system 10 in accordance with an exemplary embodiment of the present disclosure. FIG. 2 provides an enlarged view of a portion of the schematic cross-sectional view of the exemplary open rotor propulsion system 10 of FIG. 1. For reference, the open rotor propulsion system 10 defines an axial direction AX, a radial direction R, and a circumferential direction CR. Moreover, the open rotor propulsion system 10 defines an axial centerline or longitudinal axis 11 that extends along the axial direction AX. In general, the axial direction A extends parallel to the longitudinal axis 11, the radial direction R extends outward from and inward to the longitudinal axis 11 in a direction orthogonal to the axial direction AX, and the circumferential direction CR extends three hundred sixty degrees (360°) around the longitudinal axis 11.

As shown in FIGS. 1 and 2, the open rotor propulsion system 10 has a rotating element 20 that includes an array of fan airfoil blades 21 around the central longitudinal axis 11 of the open rotor propulsion system 10; thus, the rotating element 20 may be referred to as a fan assembly. The blades 21 are arranged in typically equally spaced relation around the centerline 11, and each blade 21 has a root 23 and a tip 24, and a span defined therebetween, as well as a central blade axis 22. The open rotor propulsion system 10 includes a gas turbine engine having a gas turbine engine core 49 and a low pressure (LP) turbine 50. The gas turbine engine core 49 includes a high pressure (HP) compressor 27, a combustor 28, and a high pressure (HP) turbine 29 in serial flow relationship. A high pressure (HP) shaft or rotor 26 enables the HP turbine 29 to drive the HP compressor 27. A low pressure (LP) shaft or rotor 25 enables the LP turbine 50 to drive the rotating element 20 and a generator 54. Moreover, in some embodiments as described in greater detail herein, the LP turbine 50 drives a low pressure (LP) compressor, or booster, 45 through its connection to the LP rotor 25. As shown in the figures, the rotating element 20 may be coupled to the LP rotor 25 through a power gearbox 60, which may be a star gearbox, a planetary gearbox, or other suitable gearbox. Further, as depicted, the booster 45 is disposed upstream of the gas turbine engine core 49. In some embodiments, the propulsion system 10 also may include an intermediate pressure (IP) compressor (not shown) arranged between the HP compressor 27 and the LP compressor 45 and an intermediate pressure (IP) turbine (not shown) arranged between the HP turbine 29 and the LP turbine 50.

The open rotor propulsion system 10 also includes, in the exemplary embodiment of FIG.1, a non-rotating stationary element 30 which includes an array of vanes 31 also disposed around the central axis 11, and each vane 31 has a root 33 and a tip 34 and a span defined therebetween. The vanes 31 may be arranged such that they are not all equidistant from the rotating assembly and be unshrouded (as shown in FIG. 1) or may optionally include an annular shroud or duct (not shown) distally from the axis 11. The vanes 31 are mounted to a stationary frame and do not rotate relative to the central axis 11, but may include a mechanism for adjusting their orientation relative to their axis 90 and/or relative to the blades 21. For reference purposes, FIG. 1 also depicts a forward direction denoted with arrow F, which in turn defines the forward and aft portions of the system. In the exemplary embodiment of FIG. 1, the rotating element 20 is located forward of the gas turbine engine core 49 in a “puller” configuration, and an exhaust 80 is located aft of the stationary element 30.

Left- or right-handed engine configurations, useful for certain installations in reducing the impact of multi-engine torque upon an aircraft, can be achieved by mirroring the airfoils 21, 31, and 50 such that the rotating element 20 rotates clockwise for one propulsion system and counterclockwise for the other propulsion system. As an alternative, an optional reversing gearbox, which may be located in or behind the low pressure turbine 50 or combined or associated with the power gearbox 60, permits a common gas turbine engine core 49 and low pressure turbine 50 to be used to rotate the fan blades either clockwise or counterclockwise, i.e., to provide either left- or right-handed configurations, as desired, such as to provide a pair of oppositely-rotating engine assemblies for certain aircraft installations while eliminating the need to have internal engine parts designed for opposite rotation directions. As previously indicated, the open rotor propulsion system 10 in the embodiment shown in FIG. 1 also includes a power gearbox 60, which may include a gearset for decreasing the rotational speed of the rotating element 20 relative to the low pressure turbine 50. Further, the blades 21 of the open, unducted rotating element may have a fixed pitch or blade angle or may instead have a variable pitch or blade angle to vary thrust and blade loading during operation and, in some configurations, to provide a reverse thrust configuration for aircraft deceleration upon landing.

A significant, perhaps even dominant, portion of the noise generated by the disclosed fan concept, e.g., the embodiment of FIG. 1, is associated with the interaction between wakes and turbulent flow generated by the upstream blades 21 and its acceleration and impingement on the downstream vanes 31. By introducing a partial duct acting as a shroud over the stationary vanes 31, the noise generated at the vane surface can be shielded to effectively create a shadow zone in the far field, thereby reducing overall annoyance. As the duct is increased in axial length, the efficiency of acoustic radiation through the duct is further affected by the phenomenon of acoustic cut-off, which can be employed, as it is for conventional aircraft engines, to limit the sound radiating into the far field. Further, the introduction of the shroud allows for the opportunity to integrate acoustic treatment as it is currently done for conventional aircraft engines to attenuate sound as it reflects or otherwise interacts with the liner. By introducing acoustically treated surfaces on both the interior side of the shroud and the hub surfaces upstream and downstream of the stationary vanes 31, multiple reflections of acoustic waves emanating from the stationary vanes can be substantially attenuated.

In addition to a noise reduction benefit, a duct disposed about the vanes 31 may provide a benefit for vibratory response and structural integrity of the stationary vanes 31 by coupling them into an assembly forming an annular ring or one or more circumferential sectors, i.e., segments forming portions of an annular ring linking two or more vanes 31 such as pairs forming doublets. The duct also may allow the pitch of the vanes to be varied as desired, as described in greater detail herein.

In operation, the rotating blades 21 are driven by the low pressure turbine 50 via the gearbox 60 such that they rotate around the axis 11 and generate thrust to propel the open rotor propulsion system 10 and, hence, an aircraft to which the open rotor propulsion system 10 is associated, in the forward direction F.

It may be desirable that either or both of the blades 21 or the vanes 31 incorporate a pitch change mechanism such that the blades can be rotated with respect to an axis of pitch rotation (annotated as 22 or 90, respectively) either independently or in conjunction with one another. Such pitch change can be utilized to vary thrust and/or swirl effects under various operating conditions, including to provide a thrust reversing feature which may be useful in certain operating conditions such as upon landing an aircraft.

Vanes 31 are sized, shaped, and configured to impart a counteracting swirl to the fluid so that in a downstream direction aft of both the blades 21 and vanes 31 the fluid has a greatly reduced degree of swirl, which translates to an increased level of induced efficiency. The vanes 31 may have a shorter span than the blades 21, as shown in FIG. 1, for example, the span of the vanes 31 may be 50% of the span of blades 21, or the vanes 31 may have longer span or the same span as blades 21. The vanes 31 may be attached to an aircraft structure associated with the propulsion system, as shown in FIG. 1, or another aircraft structure such as a wing, pylon, or fuselage. The vanes 31 of the stationary element 30 may be fewer or greater in number than, or the same in number as, the number of blades 21 of the rotating element 20, and typically, the vanes 31 are greater than two, or greater than four, in number.

The blades 21 may be sized, shaped, and contoured with a desired blade loading in mind. One possible blade architecture is shown and described in commonly-assigned, issued U.S. Pat. No. 10,202,865, which is incorporated herein by reference.

In the embodiment shown in FIGS. 1 and 2, an annular 360 degree (360°) inlet 70 is located between the rotating element 20 and the fixed or stationary element 30. The inlet 70 provides a path for incoming atmospheric air to enter the gas turbine engine core 49 radially inwardly of the stationary element 30. Such a location may be advantageous for a variety of reasons, including management of icing performance as well as protecting the inlet 70 from various objects and materials as may be encountered in operation.

As previously stated, FIGS. 1 and 2 illustrate what may be termed a “puller” configuration where the thrust-generating rotating element 20 is located forward of the gas turbine engine core 49. Other configurations are possible and contemplated as within the scope of the present disclosure, such as what may be termed a “pusher” configuration embodiment where the gas turbine engine core 49 is located forward of the rotating element 20. A variety of architectures are shown and described in commonly-assigned, U.S. Patent Application Publication No. 2015/0291276A1, which is incorporated herein by reference.

The selection of “puller” or “pusher” configurations may be made in concert with the selection of mounting orientations with respect to the airframe of the intended aircraft application, and some may be structurally or operationally advantageous depending upon whether the mounting location and orientation are wing-mounted, fuselage-mounted, or tail-mounted configurations.

In the exemplary embodiment of FIGS. 1 and 2, in addition to the open rotor or unducted rotating element 20 with its plurality of fan airfoil blades 21, a ducted fan 40 is included behind the open rotor rotating element 20. As such, the open rotor propulsion system 10 includes both a ducted fan and an unducted fan, which both serve to generate thrust through the movement of air at atmospheric temperature without passage through the gas turbine engine core 49. The ducted fan 40 includes an array of fan airfoil blades 39 around the central longitudinal axis 11, i.e., like the blades 21 of the rotating element 20, the blades 39 of the ducted fan 40 rotate about the central longitudinal axis 11. Thus, the rotating element 20 may be referred to as a first fan assembly and the ducted fan 40 also may be referred to as a second fan assembly or a ducted fan assembly of the open rotor propulsion system 10. As illustrated in FIGS. 1 and 2, with the ducted fan 40 disposed behind the open rotor rotating element 20, the ducted fan 40 also may be referred to as mid-fan 40.

The ducted fan 40 is shown at about the same axial location as vanes 31 and radially inward of the vane roots 33. Alternatively, the ducted fan 40 may be axially located between the vanes 31 and a core duct 72, or may be farther forward of the vanes 31. As shown in FIGS. 1 and 2, the core duct 72 is a radially inward duct downstream of the ducted fan 40 that fluidly communicates with the gas turbine engine core 49. Further, as described in greater detail below, the ducted fan 40 may be driven by the LP turbine 50 or by another suitable source of rotation, such as an electric motor or other variable speed power source, and may serve as the first stage of the booster 45 or may be operated separately.

Air entering the inlet 70 flows through an inlet duct 71 and then is divided such that a portion flows through the core duct 72 and a portion flows through a fan duct 73, which is a radially outward duct downstream of the ducted fan 40. The fan duct 73 may incorporate one or more heat exchangers 74 and exhausts to the atmosphere through an independent fixed or variable nozzle 78 aft of the stationary element 30 and outside of a gas generator core cowl 76. Air flowing through the fan duct 73 thus “bypasses” the core of the engine and does not pass through the core. The open rotor propulsion system 10, therefore, includes an unducted fan formed by the rotating element 20, followed by a ducted fan 40, which directs airflow into two concentric or non-concentric ducts 72 and 73, thereby forming a three-stream engine architecture with three paths for air that passes through the rotating element 20.

Referring particularly to FIG. 2, the ducted fan 40 may include fixed or variable outlet guide vanes (OGVs) 43 and fixed or variable inlet guide vanes (IGVs) 41, and the fan duct 73 may include struts, optionally aerodynamically shaped, such as struts 42. If a variable bleed valve (VBV) system is present, the exhaust may be mixed into the ducted fan bypass stream and exit through the nozzle 78.

With reference to FIG. 1, operation of the three-stream engine 10 may be summarized in the following exemplary manner. During operation, an initial or incoming airflow passes through the fan blades 21 of the primary fan 20 and splits into a first airflow and a second airflow. The first airflow bypasses the engine inlet 70 and flows generally along the axial direction AX outward of the fan cowl 77 along the radial direction R. The first airflow accelerated by the fan blades 21 passes through the fan guide vanes 31 and continues downstream thereafter to produce a first thrust stream S1. The vast majority of the net thrust produced by the three-stream engine 10 is produced by the first thrust stream S1. The second airflow enters the inlet duct 71 through annular engine inlet 70.

The second airflow flowing downstream through the inlet duct 71 flows through the mid-fan blades 39 of the mid-fan 40 and is consequently compressed. The second airflow flowing downstream of the mid-fan 40 is split by the splitter 61 located at the forward end of the core cowl 76. Particularly, a portion of the second airflow flowing downstream of the mid-fan 40 flows into the core duct 72 through the core inlet 64. The portion of the second airflow that flows into the core duct 72 is progressively compressed by the LP compressor 45 and HP compressor 27 and is ultimately discharged into the combustion section. The discharged pressurized air stream flows downstream to the combustor 28 where fuel is introduced to generate combustion gases or products.

More particularly, the combustor 28 defines an annular combustion chamber that is generally coaxial with the longitudinal centerline axis 11. The combustor 28 receives an annular stream of pressurized air from the HP compressor 27 via a pressure compressor discharge outlet. A portion of this compressor discharge air flows into a mixer (not shown). Fuel is injected by a fuel nozzle to mix with the air thereby forming a fuel-air mixture that is provided to the combustion chamber for combustion. Ignition of the fuel-air mixture is accomplished by one or more suitable igniters, and the resulting combustion gases flow along the axial direction AX toward and into an annular, first stage turbine nozzle of the HP turbine 29. The first stage nozzle is defined by an annular flow channel that includes a plurality of radially-extending, circumferentially-spaced nozzle vanes that turn the gases so that they flow angularly and impinge upon the first stage turbine blades of the HP turbine 29. The combustion products exit the HP turbine 29 and flow through the LP turbine 50 and exit the core duct 72 through the core exhaust nozzle 80 to produce a second thrust stream S2. For this embodiment, as noted above, the HP turbine 29 drives the HP compressor 27 via the HP shaft 26 and the LP turbine 50 drives the LP compressor 45, the primary fan 20, and the mid-fan 40 via the LP shaft 25.

The other portion of the second airflow flowing downstream of the mid-fan 40 is split by a splitter 61 (discussed in greater detail below) into the fan duct 73. The air enters the fan duct 73 through the fan duct inlet 68. The air flows generally along the axial direction AX through the fan duct 73 and is ultimately exhausted from the fan duct 73 through the fan exhaust nozzle 78 to produce a third thrust stream S3.

In certain exemplary embodiments, the thrust provided by the third thrust stream S3 may be modulated, e.g., as a function of operating conditions. More particularly, the flow of air through the fan duct 73 may be modulated based on a thrust requirement of a flight phase of an aircraft or vehicle incorporating the three-stream engine 10. For example, in the exemplary embodiment shown in FIGS. 1 and 2, a slidable, moveable, and/or translatable plug nozzle 75 with an actuator 47 may be included in order to vary the exit area of the nozzle 78. A plug nozzle is typically an annular, symmetrical device which regulates the open area of an exit such as a fan stream or core stream by axial movement of the nozzle such that the gap between the nozzle surface and a stationary structure, such as adjacent walls of a duct, varies in a scheduled fashion, thereby reducing or increasing a space for airflow through the duct. Other suitable nozzle designs may be employed as well, including those incorporating thrust reversing functionality. For example, as shown in FIG. 2, the nozzle 75 may be configured as a door or flap 75d positioned at the nozzle 78, i.e., at the aft end of the fan duct 73. Actuation for the plug nozzle 75 or door/flap 75d may be linked to the outlet guide vanes (OGVs) 43, booster variable stator vanes (VSVs), and/or variable bleed valves (VBVs) and it may be mechanically linked to booster inlet guide vanes (IGVs) 44, VBVs, and/or vane 31 actuation. Thus, the adjustable, moveable plug nozzle 75 or door/flap 75d may be designed to operate in concert with other systems such as VBVs, VSVs, or blade pitch mechanisms and may be designed with failure modes such as fully-open, fully-closed, or intermediate positions, so that the nozzle 78 has a consistent “home” position to which it returns in the event of any system failure, which may prevent commands from reaching the nozzle 78 and/or its actuator 47.

Because the open rotor propulsion system 10 includes both an open rotor rotating assembly 20 and a ducted fan assembly 40, the thrust output of both and the work split between them can be tailored to achieve specific thrust, fuel burn, thermal management, and acoustic signature objectives that may be superior to those of a typical ducted fan gas turbine propulsion assembly of comparable thrust class. The ducted fan assembly 40, by lessening the proportion of the thrust required to be provided by the unducted fan assembly 20, may permit a reduction in the overall fan diameter of the unducted fan assembly and thereby provide for installation flexibility and reduced weight. As previously stated, the fan stream through the fan duct 73 us a secondary air stream or third stream that may contributes less than 50% of the total engine thrust at a takeoff condition, such as at least 2% but less than 50% of the total engine thrust at a takeoff condition.

Operationally, the open rotor propulsion system 10 may include a control system that manages the loading of the open and ducted fans 20, 40, respectively, as well as potentially the exit area of the variable fan nozzle 78, to provide different thrust, noise, cooling capacity, and other performance characteristics for various portions of the flight envelope and various operational conditions associated with aircraft operation. For example, in climb mode, the ducted fan 40 may operate at a maximum pressure ratio, thereby maximizing the thrust capability of the fan stream through the fan duct 73, while in cruise mode, the ducted fan 40 may operate a lower pressure ratio, raising overall efficiency through reliance on thrust from the unducted fan 20. Actuation of the plug nozzle 75 modulates the ducted fan operating line and overall engine fan pressure ratio (FPR) independent of total engine airflow.

As previously mentioned, the fan duct 73 is in flow communication with one or more heat exchangers 74 to provide a thermal management function utilizing the fan stream flowing through the fan duct 73. More particularly, the ducted fan stream flowing through fan duct 73 may include one or more heat exchangers 74 for removing heat from various fluids used in engine operation (such as an air-cooled oil cooler (ACOC), cooled cooling air (CCA), etc.). The heat exchangers 74 may take advantage of the integration into the fan duct 73 with reduced performance penalties (such as fuel efficiency and thrust) compared with traditional ducted fan architectures, due to not impacting the primary or major source of thrust which is, in this case, the unducted fan stream. The heat exchangers 74 may cool fluids such as gearbox oil, engine sump oil, thermal transport fluids such as supercritical fluids or commercially available single-phase or two-phase fluids (supercritical CO2, EGV, Syltherm 800, liquid metals, etc.), engine bleed air, etc. The heat exchangers 74 also may be made up of different segments or passages that cool different working fluids, such as an ACOC paired with a fuel cooler.

The heat exchangers 74 may be incorporated into a thermal management system that provides for thermal transport via a heat exchange fluid flowing through a network to remove heat from a source and transport it to a heat exchanger. One such system is described in commonly-assigned, issued U.S. Pat. No. 10,260,419, which is incorporated herein by reference.

Each heat exchanger 74 may comprise any suitable heat exchanger design and installation, including surface coolers extending circumferentially within the fan duct 73 around a substantial portion of the inner surface of a fan cowl 77 or the outer surface of the core cowl 76, as illustrated in FIG. 2. Surface coolers typically include a single layer of cooling passages in a heat exchanger mounted to a surface over which a cooling fluid such as air passes. Alternatively, the heat exchangers 74 may be one or more discrete exchangers of the “brick” design, where the heat exchanger 74 is a discrete element with fluid conduits and heat transfer aids such as fins combined into a compact configuration that can be placed at suitable annular locations or affixed to structures such as struts or OGVs. Conventional plate-fin (or similar) orthogonal exchangers typically include several layers of fluid passages and the cooling fluid such as air passes between the passages. These “brick” type exchangers typically are more compact in overall lateral dimensions but protrude farther into the air flow, while surface coolers typically have a broader lateral dimension and protrude less into the air flow.

Because the fan pressure ratio is higher for the ducted fan 40 than for the unducted fan 20, the fan duct 73 provides an environment where more compact heat exchangers 74 may be utilized than would be possible if installed on the outside of the core cowl in the unducted fan stream. Fan bypass air is at a very low fan pressure ratio (e.g., an FPR of 1.05 to 1.08), making it difficult to drive air through heat exchangers. Without the availability of a fan duct as described herein, scoops or booster bleed air may be required to provide cooling air to and through heat exchangers. A set of parameters can be developed around heat exchangers in the fan duct 73, based on heat load, heat exchanger size, ducted fan stream corrected flow, and ducted fan stream temperature.

The fan duct 73 also provides other advantages, e.g., in terms of reduced nacelle drag, enabling a more aggressive nacelle close-out, improved core stream particle separation, and inclement weather operation. For example, exhausting the fan duct flow over the core cowl 76 aids in energizing the boundary layer and enabling the option of a steeper nacelle close-out angle between the maximum dimension of the core cowl 76 and the exhaust plane 80. The nacelle close-out angle is normally limited by air flow separation, but boundary layer energization by air from the fan duct 73 exhausting over the core cowl 76 reduces air flow separation, which yields a shorter, lighter structure with less frictional surface drag.

As previously stated, the enlarged view in FIG. 2 depicts the ducted fan outlet guide vanes (OGVs) 43, which may be fixed or variable, as well as the booster inlet guide vanes (IGVs) 44, and a splitter 61 that divides the inlet duct flow into a core stream entering the core duct 72 and a fan stream flowing through the fan duct 73. An actuator 46 may be utilized to adjust the booster IGVs 44. A pitch change mechanism 48 is also shown associated with the vanes 31 of the stationary element 30. Also, FIG. 2 depicts a variation of the ducted fan 40 in which a splittered rotor with part-span blades 39 interdigitated with full-span blades 39 may be incorporated. Splittered rotors are described in greater detail in commonly-assigned U.S. Patent Application Publication No. 2018/0017079A1, which is incorporated herein by reference.

In a variation of the configuration depicted in FIG. 2, the splitter 61 may carry forward to the aft edge of the rotating ducted fan blades 39 and the fan blades 39 themselves may include an integral splitter which effectively divides the air stream into radially inner and radially outer streams in proximity to the fan itself. This may be termed a blade-on-blade configuration where radially inner and radially outer blades are effectively superimposed upon one another and may be unitarily formed or otherwise fabricated to achieve the split between streams. Such configurations are described in greater detail in commonly-assigned, issued U.S. Pat. No. 4,043,121, which is incorporated herein by reference.

The dimensions between points identified with paired letters A-B, C-D, E-F, and G-H shown in the Drawing Figures are variables that may be tailored to provide the desired engine operating characteristics at desired flight and operating conditions.

In addition to configurations suited for use with a conventional aircraft platform intended for horizontal flight, the technology described herein could also be employed for tilt rotor applications and other lifting devices, as well as hovering devices.

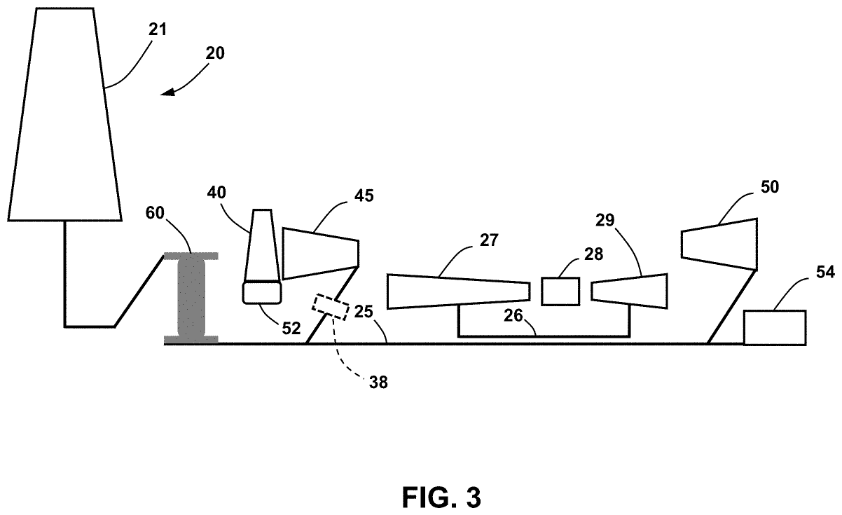

Referring now to FIGS. 3 through 6, schematic cross-sectional views are provided of exemplary propulsion systems similar in many respects to the open rotor propulsion system 10 of FIG. 1, and like numerals are utilized to refer to like elements such as, for example, ducted fan 40 and LP or booster compressor 45. As previously mentioned, in some embodiments, the ducted fan 40 and/or booster compressor 45 (or, simply, “booster 45”) may be driven by a variable speed power source 52 or may be driven by the LP turbine 50, via a connection to the LP rotor 25. More particularly, in the exemplary embodiments of FIGS. 3-6, at least one of the ducted fan 40 and the booster 45 is driven by the variable speed power source 52 such that the rotational speed of the ducted fan 40 and/or the booster 45 is controllable independently from the rotational speed of any rotor or shaft (e.g., the LP rotor 25, the HP rotor 26, or any other rotor or shaft) of the open rotor propulsion system 10.

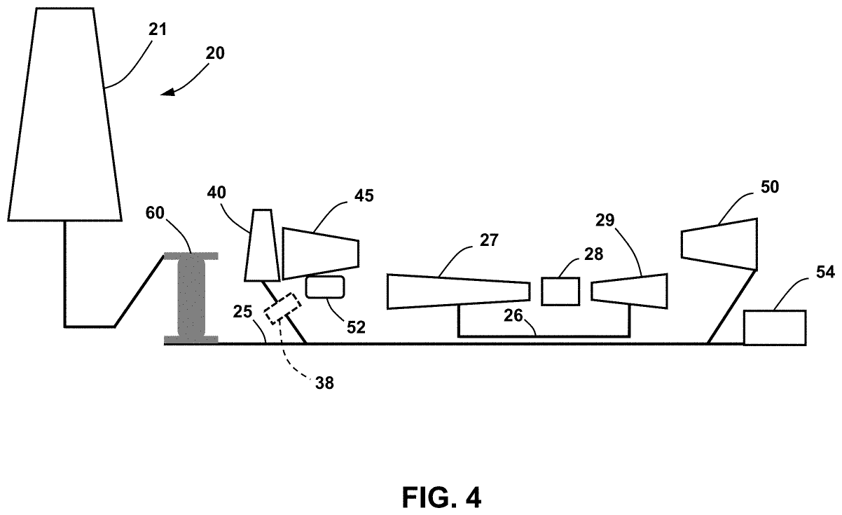

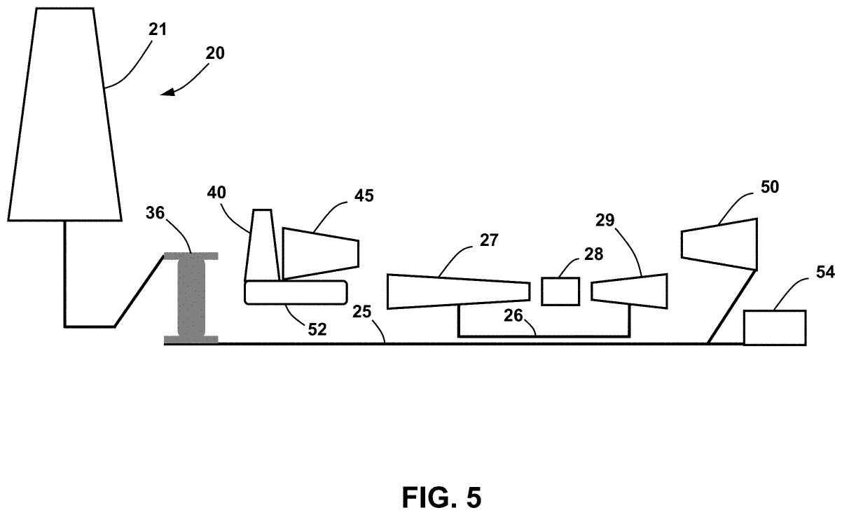

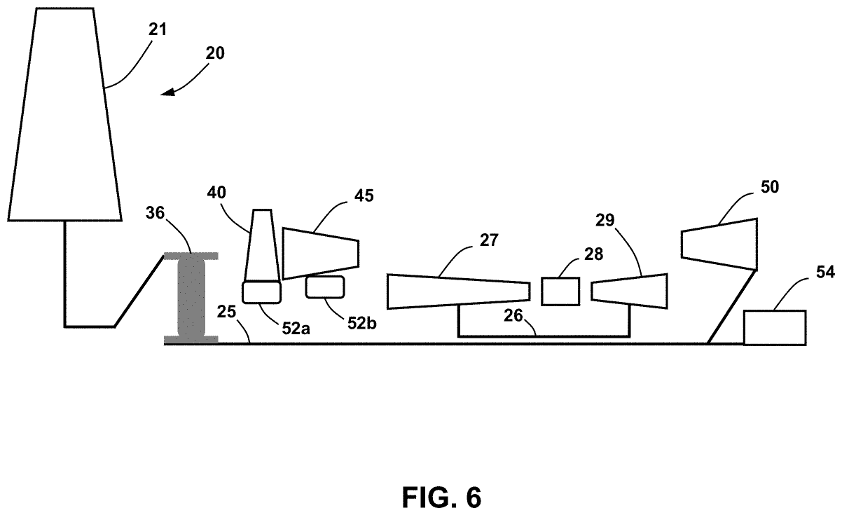

Turning particularly to FIG. 3, in one exemplary embodiment, the ducted fan 40 is driven by the variable speed power source 52 and the booster 45 is driven by the LP rotor 25. Referring to FIG. 4, in another exemplary embodiment, the ducted fan 40 is driven by the LP rotor 25 and the booster 45 is driven by the variable speed power source 52. As illustrated in FIG. 5, in yet another exemplary embodiment, both the ducted fan 40 and the booster 45 are driven by the variable speed power source 52. Referring to FIG. 6, in still another exemplary embodiment, the ducted fan 40 is driven by a first variable speed power source 52a and the booster 45 is driven by a second variable speed power source 52b. As such, for each exemplary embodiment, one or both of the ducted fan 40 and the booster 45 is controllable through a variable speed power source 52 (which includes the first variable speed power source 52a and the second variable speed power source 52b) and, thus, is controllable independently from the rotational speed of any turbine of the open rotor propulsion system 10.

Optionally, a clutch 38 may be disposed between the booster 45 and the LP rotor 25, as shown in FIG. 3, or between the ducted fan 40 and the LP rotor 25, as shown in FIG. 4, to allow the booster 45 or ducted fan 40 to be decoupled or disassociated from the rotor. That is, the clutch 38 enables the booster 45 or the ducted fan 40 to be either locked with respect to the rotor, such that the booster 45 or ducted fan 40 may be driven by the rotor, or decoupled from the rotor, such that the booster 45 or ducted fan 40 is not driven by the rotor. The clutch 38 may be a mechanical clutch, such as a friction clutch, a freewheel or overrunning clutch, or any other suitable clutch.

Thus, as described herein, the ducted fan 40 and/or the booster 45 is driven rotationally by a variable speed power source or a power transfer medium that operates the ducted fan 40 and/or the booster 45 at variable speeds depending upon, e.g., the operating conditions encountered in various phases of operation. Therefore, the ducted fan 40 and/or the booster 45 is not tied to a fixed speed ratio relative to either the LP or HP rotors 25, 26, so that the ducted fan 40 and/or the booster 45 is capable of rotating at any rotational speed desired, which may be faster or slower than either the LP or HP rotors 25, 26.

In the various exemplary embodiments, the variable speed power source 52 may be mechanical, hydraulic, electrical, or a combination thereof. More specifically, in some embodiments, the variable speed power source 52 is a mechanical variable speed drive. The mechanical variable speed drive may be a traction drive, pneumatic drive, a variable epicyclic transmission, variable fluidic coupling, or a combination thereof. A variable fluidic coupling may include a torque converter, variable displacement piston, variable georotor, or the like. In other embodiments, the variable speed power source 52 is an electrical variable speed drive, such as an electrical motor/generator. In still other embodiments, the variable speed power source is a hybrid electrical/mechanical drive. In yet other embodiments, the variable speed power source is a hydraulic variable speed drive, such as a hydraulic or hydrostatic drive.

In operation, the ducted fan 40 may operated at a higher speed during high power operations and may be operated at a lower speed, including zero speed (i.e., not operated), during low power operations. For instance, the ducted fan 40 may be driven by the variable speed power source 52 at a first, higher speed during take-off of an aircraft or other vehicle incorporating the open rotor propulsion system 10 and at a second, lower speed during cruise and/or idle of the aircraft or vehicle. In other embodiments, the ducted fan 40 may be driven by the LP turbine 50, while the booster 45 is driven by the variable speed power source 52 as illustrated in FIG. 4, during high power operations such as take-off, and the ducted fan 40 may be off or not operated during low power operation such as cruise or idle.

Moreover, the booster 45 may be operated at a lower speed during high power operations such as take-off and may be operated at higher speed (e.g., overdrive) and operating line during low power operations, such as cruise or idle. For example, a variable speed booster 45 can be overdriven such that the cruise overall operating pressure ratio (OPR) can be higher than the takeoff/top of climb OPR, thus significantly improving the thermal efficiency of the architecture and providing a new variable cycle engine feature. Further, the booster 45, as operated and described herein, may utilize the variable downstream door 75d or nozzle 75 to facilitate a higher OPR/low physical flow operation at cruise. As described herein, the booster 45 exhausts to a third stream in a three-stream engine configuration and, optionally, could back drive the core 49 during descent idle. At cruise, for example, OPRs of 80 or greater may be achievable.

Improved fuel burn at cruise and during descent may be achievable, and reductions in engine size and/or weight may be possible. Other improvements, such as improved work split between the HP compressor 27 and booster 45, and/or reductions in complexity, such as by reducing the number of or eliminating variable stator vanes (VSVs), may also be possible. The LP shaft power transmitted to the booster 45 may enable beneficial power trading from the LP rotor 25 to the HP rotor 26 during descent idle/ground idle through hydraulic, electrical, traction drive, pneumatic ADM, closed loop CO2 fluidic power transfer, torque converter/fluidic couplings, and/or mechanical/electrical variable drive systems.

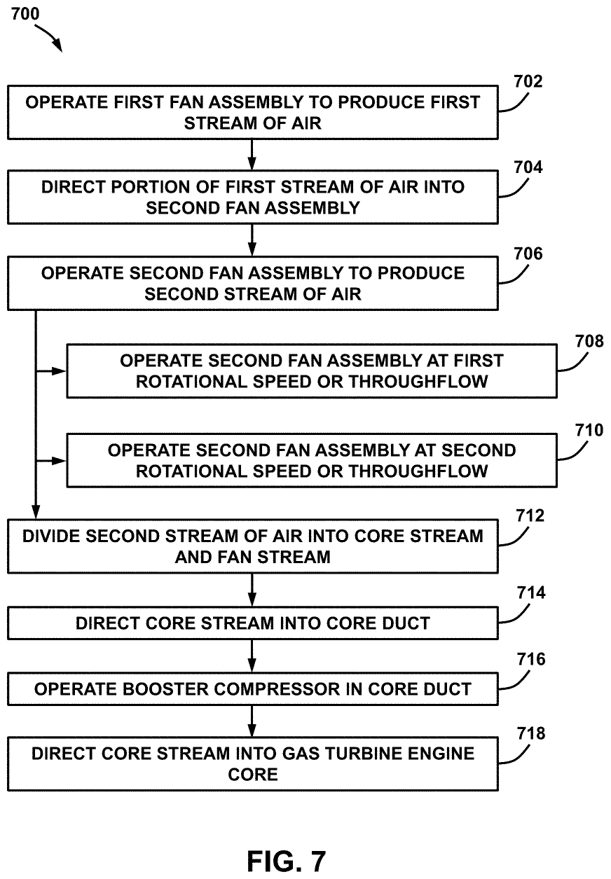

The present subject matter also provides exemplary methods of operating a propulsion system, such as the open rotor propulsion system 10 described herein according to various exemplary embodiments. Referring to FIG. 7, a flow chart is provided illustrating an exemplary method 700 of operating the open rotor propulsion system 10. As shown at block 702, the method 700 comprises operating a first fan assembly to produce a first stream of air. As previously discussed, for the open rotor propulsion system 10, the first fan assembly is the rotating element 20. Next, at block 704, the method 700 includes directing a portion of the first stream of air into a second fan assembly, which is disposed in an inlet duct. As described herein, for the open rotor propulsion system 10, the second fan assembly is the ducted fan 40, which is disposed in the inlet duct 71 having the inlet 70. As illustrated at block 706, the method 700 comprises operating the second fan assembly, or ducted fan 40, to produce a second stream of air.

More particularly, in exemplary methods of operating the propulsion system 10, the second fan assembly or ducted fan 40 is operated during a high power condition of the propulsion system and is not operated or operated a lower speed, during a low power condition of the propulsion system. That is, operating the second fan assembly or ducted fan 40 to produce the second stream of air comprises operating the second fan assembly or ducted fan 40 at a first speed during a high power condition of the propulsion system 10, as shown at block 708. The high power condition may be, e.g., during take-off of an aircraft or other vehicle incorporating the propulsion system 10. Similarly, operating the second fan assembly or ducted fan 40 to produce the second stream of air comprises operating the ducted fan 40 at a second speed during a low power condition of the propulsion system 10. For instance, the low power condition may be cruise or an idle condition of the aircraft or other vehicle incorporating the propulsion system 10. The second speed is lower than the first speed, i.e., at the low power condition, the ducted fan 40 is operated at a lower speed. In some embodiments, the second speed may be zero, or effectively zero, i.e., in some embodiments, the method 700 at block 710 includes ceasing operation of the ducted fan 40 during the low power condition.

The different operational speeds of the ducted fan 40 produces different airflows through the fan duct 73, thereby producing varying levels of thrust via the third stream of the propulsion system 10. Thus, during high power conditions, such as take-off, the ducted fan 40 may be operated to maximize thrust produced by the propulsion system 10, but during low power conditions, such as cruise or idle, the ducted fan 40 may not be operated, or may be operated at a reduced speed, to optimize thrust requirements with fuel burn, etc. to, e.g., maximize system efficiency. Further, in some embodiments, instead of or in addition to altering the speed of the ducted fan 40 (or whether ducted fan 40 is on or off), the amount of airflow through the fan duct 73 may be varied. For example, the position of the plug nozzle 75 or door/flap 75d may be varied to modulate flow through the nozzle 78 and, thereby, the fan duct 73 and the third stream of the propulsion system 10.

At block 712, the method 700 includes dividing the second stream of air into a core stream and a fan stream. As described herein, the stream of air from the ducted fan 40 (i.e., the second fan assembly) is divided into a core stream, which is directed into the core duct 72 as shown at block 714 of method 700, and into a fan stream, which is directed into the fan duct 73. At block 716, the method 700 comprises operating a booster compressor 45 disposed in the core duct 72, e.g., to compress the core stream prior to flowing the core stream to the HP compressor 27 of the gas turbine engine core 49 of the propulsion system 10. As described herein, the booster compressor 45 may be driven by the variable speed power source 52 or the LP turbine 50, through its connection to the LP rotor 25. At block 718, the method 700 includes directing the core stream into the gas turbine engine core 49.

As described herein, operating the second fan assembly (i.e., ducted fan 40) and operating the booster compressor 45 comprises operating at least one of the ducted fan 40 and the booster compressor 45 at a rotational speed independent of a rotational speed of any rotor of the propulsion system 10. For example, in some embodiments, operating the ducted fan 40 comprises operating the ducted fan 40 at a rotational speed that is greater than a rotational speed of at least one rotor of the propulsion system 10, such as a rotational speed that is greater than a rotational speed of the LP rotor 25 and/or a rotational speed of the HP rotor 26. In other embodiments, operating the ducted fan 40 comprises operating the ducted fan 40 at a rotational speed that is slower than the rotational speed of any rotor of the propulsion system 10, such as a rotational speed that is slower than a rotational speed of both the LP rotor 25 and the HP rotor 26. Moreover, in some embodiments, operating the booster compressor 45 comprises operating the booster compressor 45 at a rotational speed that is greater than a rotational speed of at least one rotor of the propulsion system 10, such as a rotational speed that is greater than a rotational speed of the LP rotor 25 and/or a rotational speed of the HP rotor 26. In other embodiments, operating the booster compressor 45 comprises operating the booster compressor 45 at a rotational speed that is slower than the rotational speed of any rotor of the propulsion system 10, such as a rotational speed that is slower than a rotational speed of both the LP rotor 25 and the HP rotor 26.

As further described herein, at least one of the second fan assembly or ducted fan 40 and the booster compressor 45 of the propulsion system 10 is operated by a variable speed power source 52. Thus, in some embodiments, the speed of the second fan assembly, i.e., ducted fan 40, may be varied using a variable speed power source 52. That is, in some embodiments, the ducted fan 40 is driven by the variable speed power source 52, such that the ducted fan 40 may be driven by the variable speed power source 52 at the first speed during the high power condition and the second, different speed during the low power condition. In other embodiments, described herein, the ducted fan 40 is driven through a connection to the rotor 25 (and the booster compressor 45 is driven by the variable speed power source 52), and in such embodiments, the first speed may be the rotational speed of the rotor 25 and the second speed may be zero, i.e., the ducted fan 40 may be effectively disconnected from (e.g., using a clutch 38) or held motionless relative to the rotor 25.

Accordingly, the present subject matter provides propulsion systems and methods of operating propulsion systems. More particularly, the present subject matter provides a propulsion system incorporating a rotating element (such as an unducted or primary fan) and a ducted fan (such as a mid-fan), as well as a booster compressor, where at least one of the ducted fan and the booster compressor is driven by a variable speed power source. Thus, at least one of the ducted fan and the booster compressor can be operated at a speed independent of both a low pressure (LP) rotor and a high pressure (HP) rotor. Operation of the ducted fan and/or booster compressor at an independent speed can maximize efficiency of the propulsion system at any operating condition. More particularly, the present subject matter may facilitate an improved fuel burn, a tailorable open rotor diameter for installation flexibility and reduced weight, and a reduced power gearbox size. Further, the present subject matter may facilitate reduced fan and core speed variation over a wide operating range, e.g., improving performance of electrical power generation systems. Moreover, the present subject matter may enable a high speed booster, higher overall pressure ratio (OPR), improved HP compressor/LP compressor (booster) pressure split, and reduced size effects. Additionally, the present subject matter may facilitate reduced nacelle drag while enabling a more aggressive nacelle close-out, as well as improve core stream particle separation and inclement weather operation. Further, the present subject matter may open up beneficial power trading from the LP rotor or spool to the HP rotor or spool, e.g., during descent idle/ground idle through hydraulic, electrical, traction drive, pneumatic ACM, or another variable drive mechanism. Other benefits and advantages of the systems described herein also may occur to those having ordinary skill in the art.

Further aspects of the invention are provided by the subject matter of the following clauses:

1. A propulsion system, comprising a rotating element; a stationary element; an inlet duct having an inlet between the rotating element and the stationary element, the inlet passing radially inward of the stationary element; a ducted fan disposed in the inlet duct downstream of the inlet, the ducted fan having an axis of rotation and a plurality of blades; a gas turbine engine core having a high pressure compressor, a combustor, and a high pressure turbine in serial relationship; and a booster compressor disposed between the ducted fan and the gas turbine engine core, wherein at least one of the ducted fan and the booster compressor is driven by a variable speed power source such that the rotational speed of the at least one of the ducted fan and the booster compressor is controllable independently from the rotational speed of any rotor of the propulsion system.

2. The propulsion system of any preceding clause, wherein the ducted fan is driven by the variable speed power source and the booster compressor is driven through a connection to a low pressure rotor by a low pressure turbine.

3. The propulsion system of any preceding clause, wherein the ducted fan is driven through a connection to a low pressure rotor by a low pressure turbine and the booster compressor is driven by the variable speed power source.

4. The propulsion system of any preceding clause, wherein both the ducted fan and the booster compressor are driven by the variable speed power source.

5. The propulsion system of any preceding clause, wherein the variable speed power source is a first variable speed power source, wherein the propulsion system further comprises a second variable speed power source, and wherein the ducted fan is driven by the first variable speed power source and the booster compressor is driven by the second variable speed power source.

6. The propulsion system of any preceding clause, wherein one of the ducted fan and the booster compressor is driven through a connection to a low pressure rotor by a low pressure turbine, and wherein a clutch is disposed between the one of the ducted fan and the booster compressor and the low pressure rotor.

7. The propulsion system of any preceding clause, wherein the variable speed power source is a mechanical variable speed drive.

8. The propulsion system of any preceding clause, wherein the mechanical variable speed drive is a traction drive, a pneumatic drive, a variable epicyclic transmission, a variable fluidic coupling, or a combination thereof.

9. The propulsion system of any preceding clause, wherein the variable speed power source is an electrical variable speed drive.

10. The propulsion system of any preceding clause, wherein the variable speed power source is a hybrid electrical/mechanical drive.

11. The propulsion system of any preceding clause, wherein the variable speed power source is a hydraulic variable speed drive.

12. The propulsion system of any preceding clause, wherein the hydraulic variable speed drive is a hydraulic drive or a hydrostatic drive.

13. The propulsion system of any preceding clause, wherein the inlet duct divides into a radially inward core duct downstream of the ducted fan and a radially outward fan duct downstream of the ducted fan.

14. The propulsion system of any preceding clause, wherein a variable nozzle is disposed at or near an aft end of the fan duct.

15. The propulsion system of any preceding clause, wherein the variable nozzle is a variable plug nozzle.

16. The propulsion system of any preceding clause, wherein the variable nozzle is configured as a door or a flap.

17. The propulsion system of any preceding clause, wherein the fan duct is in flow communication with one or more heat exchangers to provide a thermal management function utilizing a stream of air flowing through the fan duct.

18. The propulsion system of any preceding clause, wherein a stream of air flowing through the fan duct is capable of producing at least about 1% of a total thrust of the propulsion system at takeoff.

19. The propulsion system of any preceding clause, wherein a stream of air flowing through the fan duct is capable of producing at least about 1.5% of a total thrust of the propulsion system at takeoff.

20. The propulsion system of any preceding clause, wherein a stream of air flowing through the fan duct is capable of producing at least about 2% of a total thrust of the propulsion system at takeoff.

21. The propulsion system of any preceding clause, wherein the rotating element is an unducted fan rotatable about the axis of rotation and having a second plurality of blades.

22. A method of operating a propulsion system, comprising operating a first fan assembly to produce a first stream of air; directing a portion of the first stream of air into a second fan assembly, the second fan assembly disposed in an inlet duct; operating the second fan assembly to produce a second stream of air; and operating a booster compressor, wherein operating the second fan assembly and operating the booster compressor comprises operating at least one of the second fan assembly and the booster compressor at a rotational speed independent of a rotational speed of any rotor of the propulsion system.

23. The method of any preceding clause, wherein operating the second fan assembly comprises operating the second fan assembly at a rotational speed that is greater than a rotational speed of at least one rotor.

24. The method of any preceding clause, wherein operating the second fan assembly comprises operating the second fan assembly at a rotational speed that is slower than the rotational speed of any rotor of the propulsion system.

25. The method of any preceding clause, wherein operating the booster compressor comprises operating the booster compressor at a rotational speed that is greater than a rotational speed of at least one rotor.

26. The method of any preceding clause, wherein operating the booster compressor comprises operating the booster compressor at a rotational speed that is slower than the rotational speed of any rotor of the propulsion system.

27. The method of any preceding clause, wherein operating the second fan assembly comprises operating the second fan assembly at a first speed during a high power condition of the propulsion system.

28. The method of any preceding clause, wherein the high power condition is take-off of a vehicle incorporating the propulsion system.

29. The method of any preceding clause, wherein operating the second fan assembly comprises operating the second fan assembly at a second speed during a low power condition of the propulsion system, the second speed being lower than the first speed.

30. The method of any preceding clause, wherein the low power condition is cruise or idle of a vehicle incorporating the propulsion system.

31. The method of any preceding clause, further comprising ceasing operating the second fan assembly during a low power condition of the propulsion system.

32. A propulsion system, comprising an unducted fan having an axis of rotation and a first plurality of first blades; an inlet duct having an inlet downstream of the unducted fan; and a ducted fan disposed in the inlet duct downstream of the inlet, the ducted fan rotatable about the axis of rotation and having a second plurality of blades, the ducted fan driven by a variable speed power source such that a rotational speed of the ducted fan is controllable independently from a rotational speed of any rotor of the propulsion system, wherein, downstream of the ducted fan, the inlet duct divides into a radially inward core duct and a radially outward fan duct, and wherein a stream of air flowing through the fan duct is capable of producing at least about 2% of a total thrust of the propulsion system at takeoff.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

1. A propulsion system, comprising:
a rotating element;
a stationary element;
an inlet duct having an inlet between the rotating element and the stationary element, the inlet passing radially inward of the stationary element;
a ducted fan disposed in the inlet duct downstream of the inlet, the ducted fan having an axis of rotation and a plurality of blades;
a gas turbine engine core having a high pressure compressor, a combustor, and a high pressure turbine in serial relationship; and
a booster compressor disposed between the ducted fan and the gas turbine engine core,
wherein at least one of the ducted fan and the booster compressor is driven by a variable speed power source such that the rotational speed of the at least one of the ducted fan and the booster compressor is controllable independently from the rotational speed of any rotor of the propulsion system.

2. The propulsion system of claim 1, wherein the ducted fan is driven by the variable speed power source and the booster compressor is driven through a connection to a low pressure rotor by a low pressure turbine.

3. The propulsion system of claim 1, wherein the ducted fan is driven through a connection to a low pressure rotor by a low pressure turbine and the booster compressor is driven by the variable speed power source.

4. The propulsion system of claim 1, wherein both the ducted fan and the booster compressor are driven by the variable speed power source.

5. The propulsion system of claim 1, wherein the variable speed power source is a first variable speed power source, wherein the propulsion system further comprises a second variable speed power source, and wherein the ducted fan is driven by the first variable speed power source and the booster compressor is driven by the second variable speed power source.

6. The propulsion system of claim 1, wherein the ducted fan is driven through a connection to a low pressure rotor by a low pressure turbine, and wherein a clutch is disposed between the ducted fan and the rotor.

7. The propulsion system of claim 1, wherein the variable speed power source is a mechanical variable speed drive.

8. The propulsion system of claim 1, wherein the variable speed power source is an electrical variable speed drive.

9. The propulsion system of claim 1, wherein the variable speed power source is a hybrid electrical/mechanical drive.

10. The propulsion system of claim 1, wherein the variable speed power source is a hydraulic variable speed drive.

11. The propulsion system of claim 1, wherein the inlet duct divides into a radially inward core duct downstream of the ducted fan and a radially outward fan duct downstream of the ducted fan.

12. The propulsion system of claim 11, wherein a variable nozzle is disposed at or near an aft end of the fan duct.

13. The propulsion system of claim 11, wherein the fan duct is in flow communication with one or more heat exchangers to provide a thermal management function utilizing a stream of air flowing through the fan duct.

14. The propulsion system of claim 11, wherein a stream of air flowing through the fan duct is capable of producing at least about 2% of a total thrust of the propulsion system at takeoff.

15. A method of operating a propulsion system, comprising:
operating a first fan assembly to produce a first stream of air;
directing a portion of the first stream of air into a second fan assembly, the second fan assembly disposed in an inlet duct;
operating the second fan assembly to produce a second stream of air; and
operating a booster compressor,
wherein operating the second fan assembly and operating the booster compressor comprises operating at least one of the second fan assembly and the booster compressor at a rotational speed independent of a rotational speed of any rotor of the propulsion system.

16. The method of claim 15, wherein operating the second fan assembly comprises operating the second fan assembly at a rotational speed that is greater than a rotational speed of at least one rotor.

17. The method of claim 15, wherein operating the second fan assembly comprises operating the second fan assembly at a rotational speed that is slower than the rotational speed of any rotor of the propulsion system.

18. The method of claim 15, wherein operating the booster compressor comprises operating the booster compressor at a rotational speed that is greater than a rotational speed of at least one rotor.

19. The method of claim 15, wherein operating the booster compressor comprises operating the booster compressor at a rotational speed that is slower than the rotational speed of any rotor of the propulsion system.

20. A propulsion system, comprising:
an unducted fan having an axis of rotation and a first plurality of first blades;
an inlet duct having an inlet downstream of the unducted fan; and
a ducted fan disposed in the inlet duct downstream of the inlet, the ducted fan rotatable about the axis of rotation and having a second plurality of blades,
wherein, downstream of the ducted fan, the inlet duct divides into a radially inward core duct and a radially outward fan duct,
wherein a booster compressor is disposed in the radially inward core duct, the booster compressor driven by a variable speed power source such that a rotational speed of the booster compressor is controllable independently from a rotational speed of any rotor of the propulsion system, and
wherein a stream of air flowing through the fan duct is capable of producing at least about 2% of a total thrust of the propulsion system at takeoff.
